(19) United States
(12) Patent Application Publication
(10) Pub. No.: US 2026/0307476 A1
(43) Pub. Date: Oct. 8, 2026

(54) Transmission for an Electric Drive Train of a Motor Vehicle, Electric Drive Train and Motor Vehicle

(71) Applicant: Bayerische Motoren Werke Aktiengesellschaft, Muenchen (DE)

(72) Inventor: Michael STAAKE, Muenchen (DE)

(21) Appl. No.: 19/108,316

(22) PCT Filed: Oct. 13, 2023
(86) PCT No.: PCT/EP2023/078493

§ 371 Date: Mar. 3, 2025

(30) Foreign Application Priority Data
Nov. 8, 2022 (DE) 10 2022 129 428.5

(51) Int. Cl. B60K 17/16; B60K 1/00

(52) U.S. Cl. CPC B60K 17/16; B60K 1/00; B60Y 2410/102

(57) ABSTRACT

A transmission for an electric drive train of a motor vehicle comprising a transmission input shaft, which is configured to be connected to a rotor shaft of an electric traction machine in a rotationally fixed manner, an intermediate shaft engaging with the transmission input shaft, a transmission output shaft engaging with the intermediate shaft, and a transmission housing, on which the intermediate shaft and/or the transmission output shaft are rotatably mounted via two cylindrical roller bearings at their respective ends and by way of a four-point bearing.

### BACKGROUND AND SUMMARY

This disclosure relates to a transmission for an electric drive train of a motor vehicle, to an electric drive train for a motor vehicle, and to a motor vehicle with an electric drive train.

The use of transmissions in drive trains of particular motor vehicles for the purpose of adjusting an engine speed—or, to be more exact, a torque—is already generally known from the construction of production vehicles.

A transmission device of countershaft structural design with a central transmission input shaft and with a hollow transmission input shaft arranged concentrically therewith is known from DE 10 2004 043 386B4. The transmission device further includes respective countershafts which are mounted in a housing. The central transmission input shaft is mounted directly in the housing via a first bearing device in the region of its end facing away from a drive assembly.

An object of the present disclosure is to create a solution that enables a particularly efficient and acoustically optimized configuration of a transmission for an electric drive train of a motor vehicle.

The disclosure relates to a transmission for an electric drive train of a motor vehicle, in particular an automobile, in particular a passenger car. The motor vehicle is designed to be driven by way of the electric drive train with the aid of electrical energy. The motor vehicle is consequently an electric vehicle or a hybrid vehicle. The motor vehicle may include, as part of the electric drive train, an electric traction machine which is designed to provide a torque for propelling the motor vehicle. This electric traction machine may have been designed to utilize electrical energy from a battery, in particular from a high-voltage storage device of the motor vehicle, in order to generate the torque. The transmission has been provided in order to adapt the torque generated by the electric traction machine to a desired torque and consequently to transform this torque into the desired torque. The transmission is, in particular, a non-shiftable transmission.

The transmission includes a transmission input shaft which is designed to be connected in a torsion-resistant manner to a rotor shaft of an electric traction machine. This means that the torque generated by way of the electric traction machine is transmitted to the transmission input shaft via the torsion-resistant connection of the rotor shaft to the transmission input shaft. The transmission input shaft is assigned to a drive side of the transmission. The transmission further includes an intermediate shaft in engagement with the transmission input shaft. This intermediate shaft is, in particular, permanently connected in a force-transmitting manner to the transmission input shaft. Consequently the torque introduced into the transmission via the transmission input shaft can be transmitted from the transmission input shaft to the intermediate shaft. In particular, both the transmission input shaft and the intermediate shaft exhibit respective gearwheels which are in engagement with one another for transmitting the force. The transmission further includes a transmission output shaft in engagement with the intermediate shaft. This transmission output shaft is, in particular, permanently in engagement with the intermediate shaft. For this engagement, both the intermediate shaft and the transmission output shaft may exhibit respective gearwheels which are in engagement with one another for the transmission of force. The transmission output shaft is assigned to an output side of the transmission. The transmission output shaft may be operationally linked to respective wheels of the motor vehicle and may consequently provide the torque transformed in the transmission for the wheels of the motor vehicle. The transmission consequently comprises two gearing stages. The first gearing stage is constituted by the engagement between the transmission input shaft and the intermediate shaft, and the second gearing stage is constituted by the engagement between the intermediate shaft and the transmission output shaft.

The transmission further includes a transmission housing on which the intermediate shaft is rotatably mounted via two cylindrical roller bearings at its respective ends and via a four-point bearing. This means that a first cylindrical roller bearing is arranged at a first end of the intermediate shaft, and the second cylindrical roller bearing is arranged at an opposing, second end of the intermediate shaft. The four-point bearing is arranged at one of the two ends of the intermediate shaft, in particular axially adjacent to the cylindrical roller bearing assigned to the same end. This means that the four-point bearing is arranged at one of the ends, and no four-point bearing is arranged at the other end of the intermediate shaft. A first end of the intermediate shaft is consequently mounted on the transmission housing via a cylindrical roller bearing and also a four-point bearing, whereas the second end of the intermediate shaft is rotatably mounted on the transmission housing merely via the cylindrical roller bearing. The cylindrical roller bearings serve as respective floating bearings which enable a secure radial support of the intermediate shaft in the transmission housing. The four-point bearing serves as fixed bearing and enables an axial support of the intermediate shaft on the transmission housing. The axial direction and the radial direction each relate to an axis of rotation of the respective assigned shaft, the axial direction running parallel to the axis of rotation, and the radial direction being perpendicular to the axis of rotation. The respective shaft is rotated about the assigned axis of rotation during the operation of the motor vehicle.

With the described arrangement, the cylindrical roller bearings serve as radial bearings, and the four-point bearing serves as axial bearing. The cylindrical roller bearings enable a very rigid mounting of the respective shaft (the intermediate shaft or the transmission output shaft) and consequently make it possible that merely a particularly slight displacement of the tooth engagement arises between the respective shafts. Since cylindrical roller bearings are unable to support axial loads, the four-point bearing has been provided additionally by way of axial mounting. By virtue of the provision of the combination of the two cylindrical roller bearings and the four-point bearing, cylindrical roller bearings and four-point bearings configured to be particularly small can be chosen respectively for the mounting of the intermediate shaft on the transmission housing. By virtue of the fact that these mountings are particularly small, a particularly space-saving and lightweight mounting of the intermediate shaft is possible, by virtue of which, in turn, the transmission can be configured to be particularly compact and particularly light. Furthermore, merely very slight frictional losses arise in the bearings by reason of their small size.

In one possible development of the disclosure there is provision that the transmission output shaft is part of a differential. The differential is an epicyclic gear mechanism with one drive shaft and two output shafts. In this case, the intermediate shaft may be directly in engagement with a planet-wheel carrier, which may also be designated as a cage or basket, of the differential. The transmission output shaft may consequently take the form of a planet-wheel carrier or may exhibit the planet-wheel carrier. The torque that has been set by the transmission can be transmitted directly to respective wheels of the vehicle via the differential. The differential makes it possible that the wheels of the vehicle are able to rotate at different speeds. As a result, several wheels of the motor vehicle can be driven by way of a single electric traction machine. As an alternative to the configuration of the transmission output shaft as part of a differential, the transmission output shaft may have been directly connected in torque-transmitting manner to a single wheel of the motor vehicle, and a separate electric traction machine and also a separate transmission may have been provided for each wheel of the motor vehicle. By virtue of the configuration of the transmission output shaft as part of the differential, the electric drive train of the motor vehicle can be constructed to be particularly compact and also space-saving.

In a further possible configuration of the disclosure there is provision that the transmission output shaft and the intermediate shaft are each rotatably mounted on the transmission housing via two cylindrical roller bearings at their respective ends and via a four-point bearing. By virtue of the first and second gearing stages, relatively large torques arise in the intermediate shaft and in the transmission output shaft. For instance, a torque obtains on the intermediate shaft that is more than three times as great as that on the transmission input shaft, and a torque obtains on the transmission output shaft that is more than three times as great as that on the intermediate shaft. Particularly large forces consequently prevail in the intermediate shaft and in the transmission output shaft, which are to be supported on the transmission housing via the respective mountings. The cylindrical roller bearings enable a very rigid mounting of the intermediate shaft and also of the transmission output shaft, so that a particularly small displacement of the tooth engagement between the transmission input shaft and the intermediate shaft and also between the intermediate shaft and the transmission output shaft is obtained. Consequently a tilting of the shafts and/or a deformation of the shafts can be kept particularly slight. As a consequence, the transmission is particularly quiet during operation.

In a further possible configuration of the disclosure there is provision that the four-point bearing and one of the cylindrical roller bearings are arranged axially directly alongside one another and, as a result, constitute a bearing unit. This means that the four-point bearing rests in close contact with the cylindrical roller bearing that is assigned to the same end of the respective shaft. By way of this bearing unit, the respective shaft exhibiting this bearing unit can be mounted on the transmission housing particularly easily, and the bearing unit can be fastened in the transmission housing in particularly compact manner. The bearing unit enables, in addition, a particularly good stabilization of the respective shaft mounted on the transmission housing via the bearing unit.

In a further possible configuration of the disclosure there is provision that the cylindrical roller bearings are arranged along the intermediate shaft axially further outside than the four-point bearing. To the extent that the transmission output shaft is likewise rotatably mounted on the transmission housing via two cylindrical roller bearings at its respective ends and via a four-point bearing, the cylindrical roller bearings may likewise have been arranged along the transmission output shaft axially further outside than the four-point bearing. In other words, the cylindrical roller bearing is arranged closer to a nearest end of the intermediate shaft, or of the transmission output shaft, than the four-point contact bearing assigned to this cylindrical roller bearing. The four-point bearing is consequently arranged axially further inside than the cylindrical roller bearings. Along a respective length of the intermediate shaft, or of the transmission output shaft, the cylindrical roller bearings are arranged axially further outside, and the four-point bearing is arranged axially inside. As a result, the respective cylindrical roller bearings can be configured to be particularly small, and the transmission can be assembled particularly easily. In the course of an assembly of the transmission there is provision that, starting from a transmission cover, firstly a cover-side cylindrical roller bearing is positioned and then the four-point bearing is positioned. Subsequently the respective gearwheels and then the housing-side cylindrical roller bearing are positioned. As a result, use can be made of particularly compact cylindrical roller bearings. If the cover-side cylindrical roller bearing and the four-point bearing are arranged the other way round and are consequently interchanged in the axial direction, then an outer bearing raceway of this cylindrical roller bearing has to be larger than the outside diameter of the four-point bearing, in order that the transmission can be assembled and in this process the four-point bearing can be fitted by way of the pre-assembled outer ring of the cylindrical roller bearing. The cylindrical roller bearing would accordingly be distinctly larger than is necessary from the perspective of loading. In addition, with the described arrangement of the four-point bearing axially between the two cylindrical roller bearings an additional locking ring can be dispensed with.

In a further configuration of the disclosure there is provision that the intermediate shaft and the transmission output shaft are arranged parallel to one another, and the four-point bearings are assigned to the same ends of the shafts or to different ends of the shafts. This means that there is provision that both the intermediate shaft and the transmission output shaft are each mounted on the transmission housing at their ends via two cylindrical roller bearings and additionally via a respective four-point bearing. This means that the respective four-point bearings of the intermediate shaft and of the transmission output shaft may have been arranged axially at the respective same ends and consequently on the same side of the transmission, or may have been arranged at ends of the intermediate shaft and of the transmission output shaft opposing one another. The intermediate shaft and the transmission output shaft are, in particular, arranged parallel to one another and each exhibit a first end assigned to the first side and also a second end assigned to a second side situated opposite the first side. For instance, the intermediate shaft may exhibit the four-point bearing at its first end, whereas the transmission output shaft exhibits the four-point bearing at its second end. Alternatively, the intermediate shaft may exhibit the four-point bearing at its second end, while the transmission output shaft exhibits the four-point bearing at its first end. If the intermediate shaft and the transmission output shaft exhibit the four-point bearing at the same end, then the intermediate shaft and the transmission output shaft may both exhibit the assigned four-point bearing at their first end or at their second end. With an arrangement of the four-point bearings on the intermediate shaft and on the transmission output shaft on the same side and consequently at the same ends, the transmission can be assembled particularly easily, since the fixed bearings are consequently arranged on the same side of the transmission.

In particular, the respective shafts can be stabilized particularly well if the four-point bearings are arranged especially close to the gearwheels of the second gearing stage. This means that the four-point bearing on the intermediate shaft is arranged closer to the gearwheel in engagement with the transmission output shaft than to the gearwheel in engagement with the transmission input shaft. On the transmission output shaft the four-point bearing is arranged closer to the gearwheel in engagement with the intermediate shaft than to other gearwheels of the transmission output shaft. In particular, the four-point bearing may have been arranged directly axially adjacent to the gearwheel of the transmission output shaft in engagement with the intermediate shaft. As a result, the intermediate shaft and the transmission output shaft can be stabilized particularly well in the region in which the shafts are subjected to particularly high stress by reason of the transmission of force from the intermediate shaft to the transmission output shaft.

In a further possible configuration of the disclosure there is provision that the transmission input shaft is rotatably mounted on the transmission housing via at least one deep-groove ball bearing assigned to one of its ends. Deep-groove ball bearings are very efficient mountings, in which very little friction arises. In consequence, the deep-groove ball bearing enables a particularly efficient mounting of the transmission input shaft. This deep-groove ball bearing may have been arranged at a first end of the transmission input shaft, whereas the other end is connected to the rotor shaft in torsion-resistant manner. The rotor shaft may, in turn, have been rotatably mounted on the transmission housing via a so-called A-bearing which is, in particular, a further deep-groove ball bearing. Since the lowest torque within the transmission arises in the transmission input shaft, use can be made of the very efficient deep-groove ball bearing, since this is sufficient for the support of the transmission input shaft. This deep-groove ball bearing is, in addition, a particularly cost-effective rolling bearing which additionally enables both an axial support and a radial support of the transmission input shaft.

The disclosure further relates to an electric drive train for a motor vehicle, with a transmission such as has already been described in connection with the transmission according to the disclosure. The electric drive train further includes an electric traction machine, the rotor shaft of which is connected in torque-transmitting manner to the transmission input shaft of the transmission. The electric traction machine is designed to power the motor vehicle by way of the electrical energy from a battery, in particular from a high-voltage storage device of the motor vehicle, by the torque generated by the electric traction machine being transmitted to at least one wheel of the motor vehicle via the transmission. The electric drive train is consequently designed to power the motor vehicle by way of electrical energy.

The disclosure further relates to a motor vehicle with an electric drive train such as has been described in connection with the electric drive train. The motor vehicle is an electric vehicle or a hybrid vehicle.

Further features of the disclosure may be gathered from the claims, from the figures, and from the description of the figures. The features and combinations of features mentioned above in the description, and also the features and combinations of features shown below in the description of the figures and/or in the figures alone, are capable of being used not only in the respectively specified combination but also in other combinations or on their own without departing from the scope of the disclosure.

### BRIEF DESCRIPTION OF THE DRAWING

FIG. 1 shows, in a schematic sectional view, a transmission for an electric drive train of a motor vehicle.

### DETAILED DESCRIPTION OF THE DRAWING

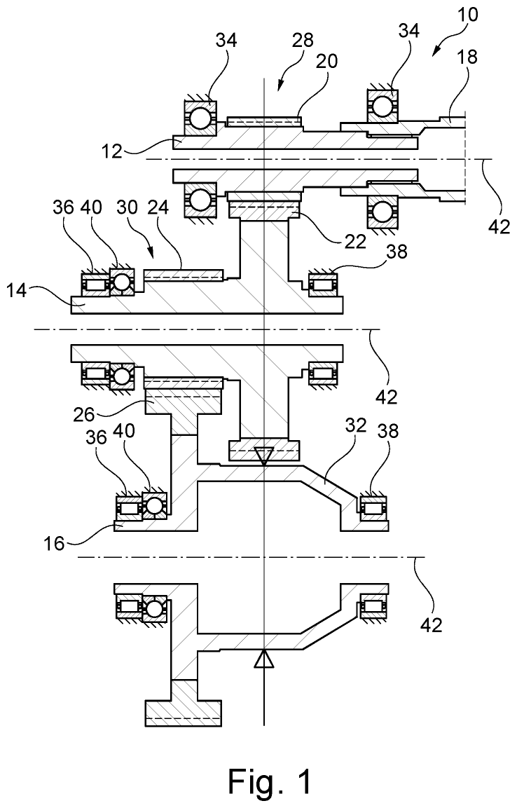

A transmission 10 for an electric drive train of a motor vehicle, in particular an automobile, in particular a passenger car, is shown in FIG. 1. The transmission 10 is designed to transform a torque received from an electric traction machine of the motor vehicle and to transmit this transformed torque, in turn, to at least one wheel of the motor vehicle. The transmission 10 is designed to transform the torque obtained from the electric traction machine in several gearing stages—in the present case, two gearing stages 28, 30.

The transmission 10 includes a transmission input shaft 12, an intermediate shaft 14 and also a transmission output shaft 16. A force in the form of a torque can be introduced into the transmission 10 via the transmission input shaft 12, the force being, in turn, provided for respective wheels of the motor vehicle via the transmission output shaft 16. In the present case, the transmission output shaft 16 is part of a differential. For this purpose, the transmission output shaft 16 exhibits the differential cage 32. The torque introduced into the transmission 10 via the transmission input shaft 12 is adjusted to the transmission output shaft 16 in respective gearing stages 28, 30 via the intermediate shaft 14. In the present case, the transmission input shaft 12 is connected to a rotor shaft 18 of the electric traction machine in force-transmitting manner, in particular in torsion-resistant manner. The transmission input shaft 12 exhibits a first pinion 20 on the outside, which is in engagement in force-transmitting manner with a first gearwheel 22 of the intermediate shaft 14. The first pinion 20 and the first gearwheel 22 are permanently in engagement with one another. The smaller, in diameter, of two gearwheels engaging with one another in a gearwheel mechanism is designated as a pinion. The intermediate shaft 14 exhibits a second pinion 24 which is in engagement—in particular, permanently in engagement—with a second gearwheel 26 of the transmission output shaft 16. The transmission 10 is consequently a non-shiftable transmission. The gearing ratio of the transmission 10 is consequently fixed. In the electric drive train, the torque, or the speed at the wheels, is consequently adjusted via the torque, or the speed of the rotor shaft 18, provided by the electric traction machine.

The first pinion 20 and the first gearwheel 22 represent a first gearing stage 28, whereas the second pinion 24 and the second gearwheel 26 represent a second gearing stage 30.

In the present case, the transmission input shaft 12 is mounted on a transmission housing, not shown in FIG. 1, of the transmission 10 via respective deep-groove ball bearings 34. In this connection, the deep-groove ball bearings 34 serve both for radial support and for axial support of the transmission input shaft 12. In the present case, the transmission input shaft 12 is rotatably mounted on the transmission housing via two deep-groove ball bearings 34. In the present case, the transmission input shaft 12 is mounted on the transmission housing directly via a first one of the deep-groove ball bearings 34 and is mounted on the transmission housing via the second deep-groove ball bearing 34 indirectly via the rotor shaft 18. In this connection, the transmission input shaft 12 has been inserted into a stub shaft of the rotor shaft 18, and this stub shaft of the rotor shaft 18 is rotatably mounted on the transmission housing via the second deep-groove ball bearing 34. This second deep-groove ball bearing 34 is a so-called A-bearing. The deep-groove ball bearings 34 are particularly efficient bearings, which means that very little friction arises in the deep-groove ball bearings 34. The first deep-groove ball bearing 34 is a so-called C-bearing which holds the transmission input shaft 12 axially and radially but exhibits play.

In the present case, both the intermediate shaft 14 and the transmission output shaft 16 are rotatably mounted on the transmission housing via a first cylindrical roller bearing 36, a second cylindrical roller bearing 38 and also a four-point bearing 40. The respective cylindrical roller bearings 36, 38 are arranged on the respective shaft axially further outside than the four-point bearing 40 assigned to the same end of the respective shaft. The respective cylindrical roller bearings 36, 38 serve as floating bearings, whereas the four-point bearing 40 serves as fixed bearing of the respective shaft. The four-point bearing 40 consequently serves for axial support of the respective shaft, whereas the cylindrical roller bearings 36, 38 serve for radial support of the respective shaft. The respective cylindrical roller bearings 36, 38 are assigned to ends of the respective shaft opposing one another. This means that the first cylindrical roller bearing 36 is arranged at a first end of the respective shaft, and the second cylindrical roller bearing 38 is arranged at a second end of the respective shaft opposing the first end. The four-point bearing 40 is assigned to one of the ends of the respective shaft. In the present case, the four-point bearing 40 is likewise assigned to the first end of the respective shaft. The four-point bearing 40 together with the first cylindrical roller bearing 36 constitutes a bearing unit. In this bearing unit, the four-point bearing 40 and the first cylindrical roller bearing 36 are arranged directly adjacent to one another in the axial direction. This means that the first cylindrical roller bearing 36 and the four-point bearing 40 are able to contact one another laterally.

As can be discerned particularly well in FIG. 1, the respective axes of rotation 42 of the transmission input shaft 12, of the intermediate shaft 14 and of the transmission output shaft 16 are oriented parallel to one another. In the present case, the respective bearing units formed from the first cylindrical roller bearing 36 and from the four-point bearing 40 are arranged on the same side both on the intermediate shaft 14 and on the transmission output shaft 16, and consequently on the left in FIG. 1. Alternatively, it is possible that the bearing units are arranged on the intermediate shaft 14 and on the transmission output shaft 16 at different ends. For instance, the bearing unit may have been arranged at the first end of the intermediate shaft 14 and at the second end of the transmission output shaft 16, or conversely. In particular, the arrangement of the bearing units is dependent on an orientation of the respective shafts or on an arrangement of the respective gearwheels, or pinions, on the shafts.

In order to keep a tilting of the intermediate shaft 14 relative to the transmission input shaft 12, or of the transmission output shaft 16 relative to the intermediate shaft 14, particularly slight, there is provision that the respective four-point bearings 40, or the respective bearing units, are arranged closer to the second gearing stage 30 than to the first gearing stage 28. This means that the four-point bearing 40 is arranged on the intermediate shaft 14 closer to the second pinion 24 than to the first gearwheel 22. In the present case, the four-point bearing 40 is arranged in the axial direction on the side of the second pinion 24 facing away from the first gearwheel 22. On the transmission output shaft 16, the four-point bearing 40 is arranged directly adjacent to the second gearwheel 26 in the axial direction. As can further be discerned in FIG. 1, the four-point bearing 40 may have been arranged on the transmission output shaft 16 radially within a toothed-wheel rim of the second gearwheel 26. This means that the four-point bearing 40 is covered, or enclosed, in a radially outward direction, at least in an axial longitudinal section, by a toothed-wheel rim of the second gearwheel 26. Consequently the four-point bearing 40 is arranged especially close to a force-introduction point of the transmission output shaft 16, the torque being introduced into the transmission output shaft 16 via the second gearing stage 30 via this force-introduction point. Since greater torques act in the second gearing stage 30 than in the first gearing stage 28, by virtue of an arrangement of the respective four-point bearings 40 especially close to the second gearing stage 30 the respective assigned shaft—in the present case, the intermediate shaft 14 or the transmission output shaft 16—can be stabilized particularly well, as a result of which a risk of tilting of the shafts can be kept particularly slight.

The respective four-point bearing 40 is fixed to the transmission housing and serves as fixed bearing of the respective assigned shaft. The transmission 10 can be assembled particularly easily if all the fixed bearings and consequently all the four-point bearings 40 are arranged on the same side of the transmission 10. The four-point bearing 40 exhibits no play or merely a particularly slight play, as a result of which an axial fixing of the respective assigned shaft is effected. The four-point bearing 40 prevents an axial displacement of the assigned shaft, the respective four-point bearing 40 being capable of being radially displaced in the transmission housing.

The torque introduced into the transmission 10 via the rotor shaft 18 is increased via the respective gearing stages 28, 30, as a result of which greater forces act in the second gearing stage 30 than in the first gearing stage 28. Particularly durable bearings are consequently advantageous for the stabilizing of the shafts implementing the second gearing stage 30. The four-point bearing 40 is particularly compact and also particularly light, and consequently has advantages in terms of weight and installation space. Since the four-point bearing 40 is not designed to support radial forces well, the cylindrical roller bearings 36, 38, which have a large radial torsional force, have been additionally provided. Through provision of the combination of the cylindrical roller bearings 36, 38 and the four-point bearing 40, use can be made in the given case of particularly small bearings which have been configured to be particularly compact and particularly lightweight. Furthermore, these bearings have particularly small frictional forces by reason of their particularly small size.

As an alternative to the configuration of the transmission 10 with the differential cage 32, the transmission 10 may exhibit the transmission output shaft 16 which is connected in torque-transmitting manner merely to a wheel of the motor vehicle. Consequently the transmission 10 may exhibit a transmission input shaft 12, an intermediate shaft 14 and also a transmission output shaft 16, according to the described arrangement, for each wheel to be driven pertaining to the motor vehicle.

The technical need underlying the described transmission 10 is to produce a transmission that is as efficient and acoustically optimized as possible for an electric drive train.

Known rolling-bearing arrangements are either very rigid, and consequently bring about a slight deformation of the transmission shafts and a slight displacement of the tooth engagement, or they are very efficient. Very rigid mountings, such as mountings using tapered roller bearings, for instance, bring about a slight displacement of the tooth engagement but are disadvantageous with regard to efficiency. Very efficient mountings, such as pure deep-groove ball bearings, for instance, are very efficient and consequently have slight loss torques, or friction torques, but bring about a relatively large deformation and/or tilting of the transmission shafts and consequently a displacement of the tooth engagement. In consequence, a broad, torque-dependent spectrum of a contact pattern results, and consequently acoustic disadvantages arise.

The transmission 10 exhibits a combination of efficient four-point bearings 40 by way of axial bearings, and cylindrical roller bearings 36, 38 by way of radial bearings. The cylindrical roller bearings 36, 38 result in a very rigid mounting and consequently in a slight displacement of the respective tooth engagements. Since the cylindrical roller bearings 36, 38 are unable to support axial loads, at least one four-point bearing 40 has been additionally provided by way of axial bearing. In the combination of this bearing concept on the differential and consequently on the transmission output shaft 16 and also on the intermediate shaft 14 and on the mounting of the transmission input shaft 12 using deep-groove ball bearings, a very slight displacement of the tooth engagements is obtained in both gearing stages 28, 30 of the arrangement represented in FIG. 1.

The motor vehicle may, in particular, exhibit an electric drive with an electric machine, with a first gearing stage 28, with a second gearing stage 30, and with a differential. Alternatively, the motor vehicle may exhibit an electric drive with two electric machines, each with a first gearing stage 28 and with a second gearing stage 30 without differential.

The transmission input shaft 12 is mounted with deep-groove ball bearings 34, the first deep-groove ball bearing 34, which is arranged adjacent to the first pinion 20, serving as fixed bearing. The intermediate shaft 14 is mounted with the four-point bearing 40 by way of fixed bearing on a transmission-cover side of the transmission housing and with two cylindrical roller bearings 36, 38 by way of floating bearings or radial bearings. The transmission output shaft 16, or the differential cage 32, is mounted with the four-point bearing 40 by way of fixed bearing on the transmission-cover side and with two cylindrical roller bearings 36, 38 by way of floating bearings or radial bearings. The respective four-point bearing 40 is in each instance radially released in the transmission cover of the transmission housing or on the transmission shaft. Consequently, no radial force is transmitted to the four-point bearing 40, which serves purely as axial bearing or fixed bearing. A compression of the respective bearing-points in the same direction, and consequently a tilting or deformation of the transmission shafts in the same direction, and consequently a slight radial displacement and angular deviation of the gearwheels in engagement relative to one another, and consequently a slight deviation in the tooth engagement, are obtained by virtue of the proposed arrangement.

By virtue of the arrangement of the bearings of spur gears in the installation space or in the transmission 10, accessibility to locking elements of the fixed bearings is restricted. Fitting of standard locking rings within the transmission 10 is not possible on the differential, and only possible to a limited extent on the intermediate shaft 14. Consequently an aperture can be generated in the transmission cover in the region of the locking ring, through which the respective locking ring can be actuated from outside. The aperture can be closed after the fitting of the locking ring.

Overall, the disclosure shows how a rolling-bearing concept with separate radial mounting and axial mounting can be created for a transmission 10 of an electric drive.

### LIST OF REFERENCE SYMBOLS

10 transmission
12 transmission input shaft
14 intermediate shaft
16 transmission output shaft
18 rotor shaft
20 first pinion
22 first gearwheel
24 second pinion
26 second gearwheel
28 first gearing stage
30 second gearing stage
32 differential cage
34 deep-groove ball bearing
36 cylindrical roller bearing
38 cylindrical roller bearing
40 four-point bearing
42 axis of rotation

1.-9. (canceled)

10. A transmission for an electric drive train of a motor vehicle, comprising:
a transmission input shaft for connection in a torsion-resistant manner to a rotor shaft of an electric traction machine,
an intermediate shaft in engagement with the transmission input shaft,
a transmission output shaft in engagement with the intermediate shaft, and
a transmission housing on which the intermediate shaft is rotatably mounted via two cylindrical roller bearings at its respective ends and via a four-point bearing.

11. The transmission according to claim 11, wherein:
the transmission output shaft is part of a differential.

12. The transmission according to claim 10, wherein:
the transmission output shaft and the intermediate shaft are each rotatably mounted on the transmission housing, in each instance via two cylindrical roller bearings at their respective ends and via a four-point bearing.

13. The transmission according to claim 10, wherein:
the four-point bearing and one of the cylindrical roller bearings are arranged axially directly alongside one another and, as a result, constitute a bearing unit.

14. The transmission according to claim 10, wherein:
the cylindrical roller bearings are arranged along the intermediate shaft axially further outside than the four-point bearing.

15. The transmission according to claim 12, wherein:
the intermediate shaft and the transmission output shaft are arranged parallel to one another, and the four-point bearings are assigned to the same ends of the shafts or to different ends of the shafts.

16. The transmission according to claim 10, wherein:
the transmission input shaft is rotatably mounted on the transmission housing via at least one deep-groove ball bearing assigned to one of its ends.

17. An electric drive train for a motor vehicle, with a transmission according to claim 10, and also with an electric traction machine, the rotor shaft of which is connected in torque-transmitting manner to the transmission input shaft of the transmission.

18. A motor vehicle with an electric drive train according to claim 17.
